(19) United States
(12) Patent Application Publication
(10) Pub. No.: US 2023/0010311 A1
(43) Pub. Date: Jan. 12, 2023

(54) Method for Determining the Visibility of a GNSS Satellite and Method for High-Precision Position Determination, as well as a Computer Program, Electronic Storage Medium and Device

(71) Applicant: Robert Bosch GmbH, Stuttgart (DE)

(72) Inventor: Marcus Wagner, Schwaigern (DE)

(21) Appl. No.: 17/786,396

(22) PCT Filed: Nov. 17, 2020
(86) PCT No.: PCT/EP2020/082377

§ 371 Date: Jun. 16, 2022

(30) Foreign Application Priority Data
Dec. 18, 2019 (DE) 10 2019 220 051.6

(51) Int. Cl. G01S 19/26

(52) U.S. Cl. CPC G01S 19/26

(57) ABSTRACT

The disclosure relates to a method for determining the visibility of a satellite for a GNSS-based position determination, including: detecting the environment in a position, in particular determining an unobstructed view of the sky, by means of an environment sensor system and/or a GNSS sensor system and/or a camera sensor system; and merging the detected environment, in particular the unobstructed view of the sky, with a theoretical visibility of a satellite in the position.

The present invention provides a method for determining the visibility of a satellite and a method for high-precision position determination and a corresponding computer program, a corresponding electronic storage medium and a corresponding device.

### PRIOR ART

In order to determine a position for a vehicle, it is known to fuse data from a (global) navigation satellite system (GNSS) with data from an inertial sensor system that is arranged in the vehicle. This fusion makes it possible, inter alia, to achieve an accuracy in the position determination that would not be able to be achieved by way of a GNSS alone, on the one hand, and that is necessary for at least partially automated driving, on the other hand.

The availability of the data is essential for the position determination. For data from the inertial sensor system, there are large numbers of empirical values in particular from the field of driving stability control with regard to availability. Although there is knowledge about the theoretical visibility of a GNSS satellite for data from the GNSS, the theoretical visibility assumes an uninterrupted view of the GNSS satellites or the clouds or the sky. In this case, the theoretical visibility is strongly influenced, inter alia, by geographical factors (including mountains, valleys and the like), urban factors (including buildings, tunnels and the like) and weather factors (including clouds, precipitation and the like).

### DISCLOSURE OF THE INVENTION

Against this background, the present invention provides a method for determining the visibility of a satellite for GNSS-based position determination, having the following steps:
detecting the surroundings at a position by way of a surroundings sensor system and/or a GNSS sensor system and/or a camera sensor system;
fusing the detected surroundings with a theoretical visibility of a satellite at the position.

In the step of detecting the surroundings, the uninterrupted viewing angle is in this case in particular ascertained, and accordingly the uninterrupted view of the clouds or the sky is ascertained.

Using the method of the present invention, it is now possible to determine a more accurate number of visible GNSS satellites for a particular region, therefore for the region that is encompassed by the position or the positions of the detected surroundings. A method or a device for high-precision position determination may thereby be made more available or highly available.

Highly available may be understood here to mean that the position determination provided by the method or the device for high-precision position determination is able to be made available with a sufficiently high reliability and sufficiently high accuracy in order to be able to implement those functions of the advanced driver assistance system (ADAS) and functions of at least partially automatically operated vehicles (automated driving, AD) that rely on the position determinations.

In the context of the invention, conceivable positions or surroundings may include the around 13,000 km of the autobahn network currently present in Germany.

A direct method product of the method of the present invention may be a database that comprises data about the actually possible visibility of a GNSS satellite based on a fusion of the detected visibility and the theoretical visibility of a GNSS satellite at the position of the detected surroundings. Based on this knowledge, methods for satellite-assisted position determination appropriate for the corresponding positions or sections may be applied taking into consideration the actually possible visibility of a or the GNSS satellite in order to perform position determination. Those positions or sections that have a reduced actual visibility of GNSS satellites are of particular importance here.

This makes it possible to introduce any necessary extra effort for achieving high-precision position determination with reduced visibility of GNSS satellites in a considerably more demand-oriented manner. This may on the whole lead to less complex and thus resource-saving position determination.

According to one embodiment of the method of the present invention, the method comprises the additional step of acquiring the time of the surroundings detection. In this embodiment, the acquired time is additionally taken into consideration in the fusion step.

Taken into consideration in the fusion step may be understood to mean here that the time dimension is taken into consideration in the fusion, since both the theoretical visibility and the actual possible visibility are both location-dependent and time-dependent. The sole exception to this are navigation satellite systems with geostationary satellites. Such systems are very rare at present and available or present in a very locally restricted manner.

According to one embodiment of the method of the present invention, methods for analyzing camera data in order to identify objects are applied in the detection step.

The methods for analyzing camera data in order to identify objects may in this case take place in the ascertaining step in the course of the detection step.

The methods are used inter alia to identify houses and mountains in camera data. These are objects that restrict the visibility of GNSS satellites.

The addressed methods are not a core aspect of the present invention and are familiar to a corresponding person skilled in the art in this field.

A further aspect of the present invention is a method for position determination by way of data fusion of data from a GNSS sensor and data from an inertial sensor. In this case, for the position determination, method results of the method for determining the visibility of a satellite according to the present invention are taken into consideration.

By way of this aspect of the present invention, it is possible to perform high-precision position determination.

High-precision position determination should be understood here to mean position determination that is accurate enough, in spite of the remaining determination error, to implement those functions of the advanced driver assistance system (ADAS) and functions of at least partially automated driving (AD) that rely thereon.

A further aspect of the present invention is a computer program that is designed to execute all of the steps of one of the methods according to the present invention.

A further aspect of the present invention is an electronic storage medium on which the computer program according to the present invention is stored.

A further aspect of the present invention is a device that is designed to carry out all of the steps of one of the methods according to the present invention.

Embodiments of the present invention are explained in more detail below with reference to a drawing, in which:

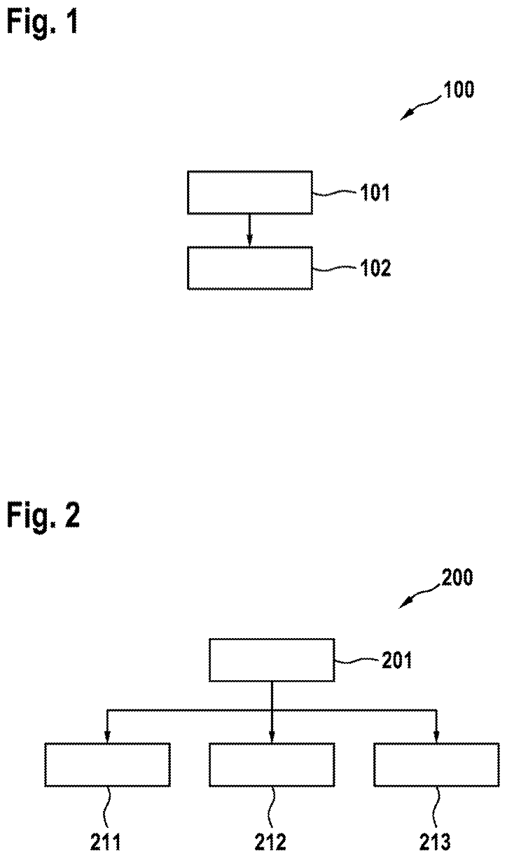

FIG. 1 shows a flowchart of one embodiment of the method of the present invention;

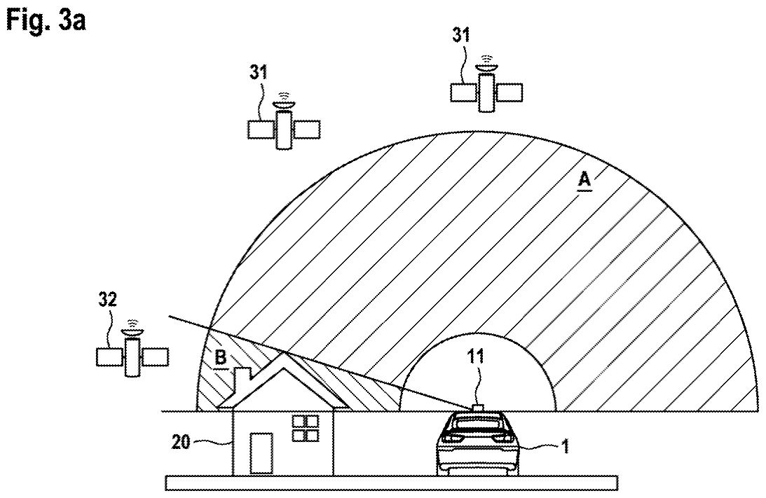

FIG. 2 shows a flowchart for detecting the surroundings at a position according to the method of the present invention;

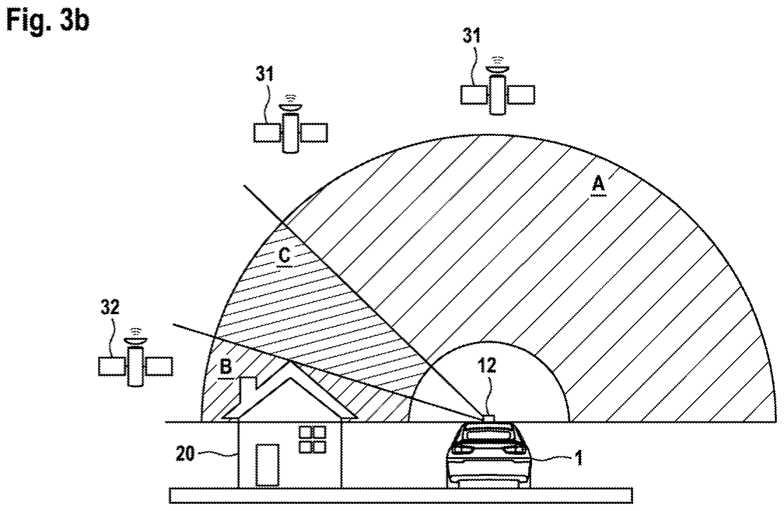

FIG. 3a shows a schematic illustration of the detection of the visibility of a GNSS satellite based on special measurement technology;

FIG. 3b shows a schematic illustration of the detection of the visibility of a GNSS satellite based on a method and a device for high-precision position determination.

FIG. 1 shows a flowchart of one embodiment of the method 100 of the present invention.

In step 101, the surroundings are detected at a position by way of a surroundings sensor system or a GNSS sensor system or a camera sensor system.

One of the purposes of the detection 101 is to ascertain the uninterrupted view or the uninterrupted viewing angle of the GNSS satellites or the clouds or the sky.

The detection 101 may in this case be performed for example by an appropriate sensor system that is installed on a vehicle that has been moved to the position at which the detection is intended to take place. As an alternative, the detection could be performed by an appropriate sensor system that has been placed at the position at which the detection is intended to take place.

The sensor system may be for example a surroundings sensor system that is designed specifically to detect the visibility of GNSS satellites. Radar systems and laser systems are primarily suitable for this purpose.

As an alternative or in addition, a GNSS sensor system may be used for the detection.

As an alternative or in addition, a camera sensor system may be used for the detection. A camera sensor system is generally designed to detect electromagnetic radiation in the visible region (for example video camera) or in a region close to the visible region (for example infrared camera).

In step 102, the detected surroundings are fused with a theoretical visibility of a satellite at the position.

The purpose of the fusion step 102 is to enrich the theoretical visibility of a GNSS satellite, which results essentially from the position of the observation and the position of the satellite in orbit, with the detected surroundings information so as to give, as a result, an actually possible visibility of the GNSS satellite. By way of example, there may thus be a theoretical visibility of a GNSS satellite at a particular position that is actually however not possible since there is an obstacle, such as for example a building or a landscape feature, such as for example a mountain, in the line of sight to the GNSS satellite.

FIG. 2 shows a flowchart for detecting the surroundings at a position according to the method 100 of the present invention.

The depicted step 201 corresponds essentially to step 101 of the flowchart of FIG. 1. In this step, the uninterrupted visibility of the clouds is detected.

The detection in accordance with step 211 may in this case be performed using a surroundings sensor system that is designed specifically for detecting uninterrupted visibility.

As an alternative or in addition, the detection in step 212 may be performed by way of a device for high-precision position determination based on a fusion of data from a GNSS sensor with data from an inertial sensor.

As an alternative or in addition, the detection in step 213 may be performed by way of a camera sensor system.

The present invention may be used in the context of detecting the visibility of GNSS satellites in a limited region in order for example to achieve an improvement in accuracy for the position determination in this region.

It is conceivable here to achieve visibility of GNSS satellites from positions on autobahns in Germany. The German autobahn network at present comprises around 13,000 km.

The invention is not intended to be restricted here to the territory of the Federal Republic of Germany. The invention may likewise be applied to other territories or even worldwide.

FIG. 3a shows a schematic illustration of the detection of the visibility of a GNSS satellite 31, 32 based on a surroundings sensor system 11.

In the illustration, the surroundings sensor system 11 is arranged on a vehicle 1. As an alternative, the surroundings sensor system 11 could be placed at the position at which the detection is intended to take place.

The GNSS satellites 31, 32 are theoretically visible from the position of the vehicle 1.

The illustration also illustrates an obstacle 20 that makes the theoretical visibility of the GNSS satellite 32 impossible.

The surroundings sensor system 1 is designed to detect the visible regions A and the non-visible regions B in the sky above the position of the detection. Radar systems and laser systems are primarily suitable for this purpose.

FIG. 3b shows a schematic illustration of the detection of the visibility of a GNSS satellite 31, 32 by way of a GNSS sensor 12. Such a sensor may be for example a device for high-precision position determination.

In the illustration, the GNSS sensor 12 is arranged on a vehicle 1. As an alternative, the GNSS sensor 12 could be placed at the position at which the detection is intended to take place.

The GNSS satellites 31, 32 are theoretically visible from the position of the vehicle 1.

The GNSS sensor 12 detects the actually visible satellites 31. Through a comparison with the theoretically visible satellites 31, 32, it is possible to ascertain the non-visible satellite 32. From this information, it is possible to derive the regions A, B, C of uninterrupted visibility A and blocked visibility B. From the illustration, it is furthermore possible to identify a region C at which it is not possible to make any statement about visibility.

These unclear regions C may, according to one embodiment of the present invention, be reduced or completely eliminated through fusion with a further sensor system, for example through a surroundings sensor system 11 or a camera sensor system.

The data detected according to the first aspect of the present invention regarding the visibility of GNSS satellites may on the one hand, according to the second aspect of the present invention, be used specifically for high-precision position determination, in particular in the context of advanced driver assistance systems (ADAS) and at least partially automated driving (AD).

On the other hand, the data detected according to the first aspect of the present invention may be used for extensive evaluation of the visibility of GNSS satellites.

For instance, autobahns or sections of autobahns may for example be evaluated offline, that is to say without the sections in question having to be driven on (possibly at different times of day/in different weather conditions and the like), in terms of coverage by GNSS satellites. Sections that require a large amount of outlay for high-precision position determination, for example because the visibility of GNSS satellites is below average in terms of distance or time, are thus able to be ascertained quickly and easily.

Proceeding from these findings, the methods for high-precision position determination may be adapted accordingly or the route sections in question may be enhanced with assistive infrastructure objects such that high-precision position determination is possible even without a sufficient number of visible GNSS satellites.

Such infrastructure objects may for example be devices for triangulation or for visual navigation.

1. A method for determining the visibility of a satellite for GNSS-based position determination, comprising:
detecting the surroundings at a position, in particular by ascertaining an uninterrupted view of the sky, by way of a surroundings sensor system and/or a GNSS sensor system and/or a camera sensor system; and
fusing the detected surroundings, in particular by fusing the ascertained uninterrupted view of the sky with a theoretical visibility of a satellite at the position.

2. The method as claimed in claim 1, further comprising:
acquiring a time of the surroundings detection, wherein the acquired time is additionally taken into consideration in the fusion step.

3. The method (100) as claimed in claim 1, wherein detecting the surroundings further comprises:
analyzing camera data in order to identify objects, in particular, houses and mountains.

4. A method for high-precision position determination, using data fusion of data from a GNSS sensor and data from an inertial sensor, comprising:
detecting surroundings at a position, by ascertaining an uninterrupted view of the sky, by way of a surroundings sensor system and/or a GNSS sensor system and/or a camera sensor system; and
fusing the detected surroundings, by fusing the ascertained uninterrupted view of the sky with a theoretical visibility of a satellite at the position.

5. The method of claim 4, wherein the method is performed by executing a computer program that is designed to execute the method.

6. The method of claim 5, wherein the computer program is stored on an electronic storage medium.

7. A device, comprising:
a computer program that is designed to
detect surroundings at a position, by ascertaining an uninterrupted view of the sky, by way of a surroundings sensor system and/or a GNSS sensor system and/or a camera sensor system; and
fuse the detected surroundings, by fusing the ascertained uninterrupted view of the sky with a theoretical visibility of a satellite at the position.
